(19) United States
(12) Patent Application Publication
(10) Pub. No.: US 2006/0156937 A1
(43) Pub. Date: Jul. 20, 2006

(54) Device comprising a sieve drum, which is radially flown through by a fluid, and permeable bellows that surround the sieve drum

(76) Inventor: Gerold Fleissner, Zug (CH)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/544,087

(22) PCT Filed: Feb. 18, 2004
(86) PCT No.: PCT/EP04/50147

§ 371 Date: Jul. 29, 2005

(30) Foreign Application Priority Data
Feb. 19, 2003 (DE) 10307074.5

(51) Int. Cl. B41F 23/04

(52) U.S. Cl. 101/416.1

(57) ABSTRACT

The invention relates to a device comprising a rotationally mounted drum, which is flown through by a fluid from the exterior to the interior. The stable casing of the drum is provided over the periphery thereof with a sieve-shaped hole structure. The inventive device also comprises permeable outer bellows, which radially cover the casing on the exterior. One more support such as wire gauze is optionally placed between said outer bellows and the sieve drum casing in order to increase the distance between the sieve drum casing and the outer bellows. According to the invention, a tensioning element, which extends in an axial direction and which is enlarged at least once in a radially direction over the working width of the sieve drum, is mounted in a manner that enables it to be axially displaced in order to tension, in any case, the outer bellows with the sieve drum lateral surface between the outer surface of the sieve drum casing and the inner surface of the outer bellows. After the tensioning element is displaced in an axial direction, the outer bellows are brought into frictional contact in an all-over manner with the sieve drum lateral surface whereby preventing the formation of folds in the outer bellows over a long period of time.

The invention relates to a device comprising a rotatably mounted drum through which fluid flows from outside to inside, whose stable casing is provided over the circumference with a sieve-like perforated structure or the like, and furthermore with a likewise permeable outer covering which covers the casing radially on the outside and preferably an intermediate layer such as screen fabric is arranged between said covering and the casing of the perforated drum to increase the distance between the casing of the perforated drum and the outer covering.

A device of this type is known from DE-U-1 886 883 or DE-A-1 806 220. This has the advantage that the air or water flow through the textile material lying on the drum is uniformly distributed over the width. No column-like fluid flow is formed depending on the perforation of the casing of the perforated drum carrying the textile material but the fluid is distributed uniformly over the surface and the suction from inside the drum acts uniformly on the surface of the textile material.

A screen fabric can easily be applied smoothly and under tension to the surface of the perforated drum. A hose is produced with a diagonal fabric structure, having a sufficiently large diameter over the drum and is then pulled smoothly onto the drum at the ends of the drum where there is a reduction in diameter and is held there under tension. Various devices are known for clamping and for this reference is made to DE-A-1 729 487 and DE-A-101 11 335. However, this type of fixing, this type of joining of the outer covering to the surface of the perforated drum over its entire area can only be achieved using tubular fabric manufactured in this way, a rigid fluid-permeable plastic film or a corresponding sheet-metal casing cannot be distorted laterally and thus brought to rest on the bearing perforated drum. The tubular outer covering of sheet metal or film is usually manufactured so that it fits as exactly as possible and then pulled over the drum during assembly. In this case, major problems occur not only as a result of the friction of the covering on the outer surface of the drum but, since a certain play, a certain spacing, must be present between the covering and the drum during assembly, as a result of the remaining play which remains permanently on the drum, the covering will become distorted on the drum as a result of the longitudinal tension in the direction of the circumference of the drum, which can result in creasing and distortions in the covering.

It is the object of the invention to find a solution for this problem. A rigid film or a fine perforated sheet manufactured in a tubular shape and provided with the desired defect-free perforation around the circumference should be clamped fixedly on the supporting casing of the perforated drum.

Starting from the device of the type specified initially, the object is solved by mounting a clamping element extending in the axial direction and enlarged at least once in the radial direction over the working width of the perforated drum axially displaceably between the outer surface of the casing of the perforated drum and the inner surface of the outer covering. The intrinsically rigid outer covering is manufactured unchanged so that it fits exactly. Now, however, the clearance required for the assembly in any case is made ineffective by a radially outwardly directed clamping of the outer covering. Said covering will then lie fixedly on the perforated drum, located there under friction whereas the clamping line only unnoticeably undergoes an enlargement in diameter of the height of the clamping element extending over the working width.

For this purpose it is provided in the embodiment to mill a groove into the outer casing of the perforated drum over the length of its working width, into which the clamping element having the same width and height is inserted with some play. The inserted clamping element thus ends with the surface of the perforated drum in the assembled state of the outer covering. In addition, the groove has at least one indentation over its length into which the radial enlargement of the clamping element is inserted radially inwards. If the clamping element is now displaced axially after assembling the outer covering in the longitudinal direction of the drum, the radial enlargement of the clamping element is shifted into the area of the air gap between the inner surface of the outer covering and the outer surface of the perforated drum and thus clamps the outer covering so that it rests on the surface of the perforated drum. The clamping element can be made of spring steel and the radial enlargement can be a bend in the direction of the indentation in the groove of the perforated drum. After displacing the clamping element out from the indentation, two supporting regions for the outer covering are obtained on both sides of the radial enlargement over the length of the clamping element. Naturally, this type of bracing can be produced many times over the length of the working width of the drum and/or over the circumference of the drum.

A device of the type according to the invention is shown as an example in the drawings. In the figures:

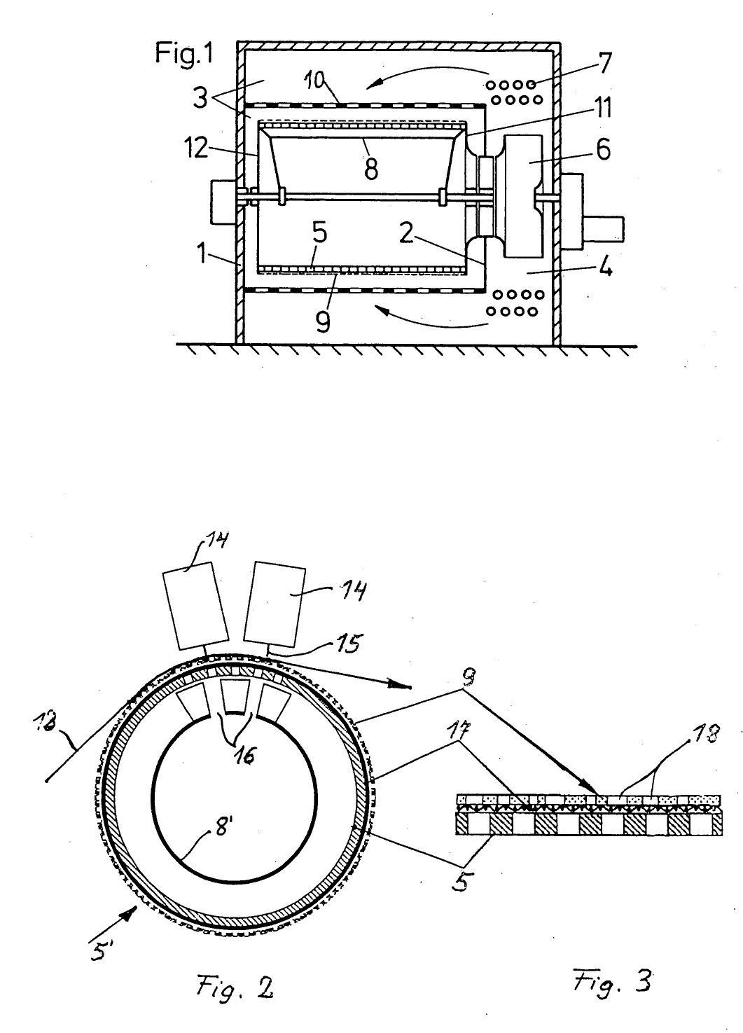

FIG. 1 shows a section longitudinally through a conventional perforated drum device for drying, whose sheet metal casing comprises a perforated drum casing with a sheet metal casing pulled on externally,

FIG. 2 shows a cross-section through a permeable perforated drum under suction for transporting a nonwoven to be compacted with water jets with nozzle bars associated externally with the perforated drum to produce hard water jets,

FIG. 3 shows an enlarged view of the casing of the perforated drum from FIG. 2,

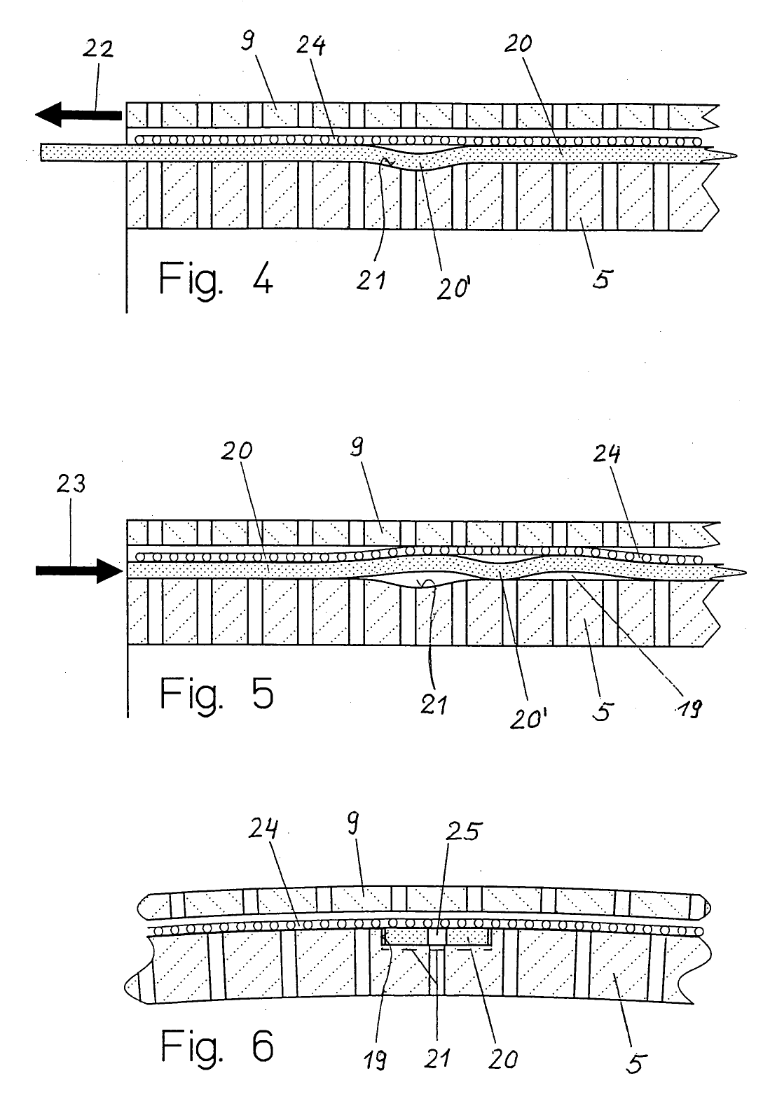

FIG. 4 shows in a longitudinal section of the perforated drum, the casing of the perforated drum from FIG. 1 or 3 again in an enlarged view with the clamping element in the mounted state of the outer covering, likewise in sectional view,

FIG. 5 shows in a longitudinal section of the perforated drum, the casing of the perforated drum from FIG. 4 with the clamping element displaced in the clamping state of the outer covering and

FIG. 6 shows a cross-section of the casing of the perforated drum from FIG. 1 or 3 with the clamping element in the mounted state as in FIG. 4.

A perforated drum device for drying fundamentally consists of an approximately rectangular housing 1 which is divided into a treatment compartment 3 and a fan compartment 4 by an intermediate wall 2. The perforated drum 5 is rotatably mounted in the treatment compartment 3 and concentrically thereto a fan 6 is rotatably mounted in the fan compartment behind the nozzle star. Naturally, the fan compartment can also be arranged in a separate fan housing not shown here, separated from the housing 1 of the perforated drum. In any case, the fan sets the interior of the drum 5 under suction.

According to FIG. 1, heaters 7 are arranged above and below the fan 6, and comprise pipes through which heating medium flows. The heated air is then blown into the stagnation space above and below the perforated drum which is bounded by the stagnation cover 10. This ensures a uniform air distribution over the working width. The perforated drum is covered on the inside against the suction by an inner cover 8 supported on the axle in the area not covered by the textile material. The casing structure of the perforated drum carrying the textile material is formed here by the drum with a sheet-metal-like outer covering 9, for example, supported on the bases 11, 12 described hereinafter with reference to FIG. 3 ff.

The type of bracing of the outer covering with the perforated drum as shown in FIGS. 4-6 can be used both for drying material webs using a device as shown in FIG. 1 and for hydrodynamic needling of nonwovens as shown in FIGS. 2-3. The perforated drum 5′ which can be seen from FIG. 2 also has other peripheral parts which are omitted here for clarity. The nonwoven 13 to be acted upon runs directly over the perforated drum 5′ with which one or a plurality of nozzle bars 14 are directly associated on the outside. The respective nozzle bar 14 is arranged axially parallel to the perforated drum 5′ and on its underside associated with the perforated drum 5′ is provided a nozzle strip not shown here to form the water jets 15. As usual, the perforated drum 5′ is under suction to extract the sprayed water for which purpose a suction pipe 8′ is arranged centrally inside the perforated drum 5′ which has suction slits 16 extending to the perforated drum 5′ which in turn have associated nozzle bars 14.

The perforated drum 5′ according to FIG. 2 consists of a seamless perforated drum wall 5 which serves as a supporting element for the outer covering 9 which is drawn on from outside. A fine screen fabric, a spunlace web 17 is first clamped on the casing of the perforated drum 5 as shown in FIG. 3, and then this outer covering 9 is drawn thereon as sheet metal or film.

In both cases of the device in FIG. 1 or 2, the outer covering 9 must be manufactured as tube, as hose with the desired perforation and without a recognisable seam and drawn on the drum with the casing sheet metal 5 in the axial direction. For this purpose it is necessary to have a certain play between the inner surface of the outer covering 9 and the outer surface of the perforated drum casing 5. This necessary play during assembly is disadvantageous for the prescribed use of the drum. The outer covering 9 should be secured reliably against slippage on the front sides of the drum but during usage torques occur continuously in the circumferential direction on the outer covering which can result in creasing or even bending in the covering depending on the sensitivity of the outer covering. Sufficient frictional connection between the perforated drum casing 5 and the covering 9 over the entire area is lacking.

To solve this problem, as shown in FIG. 6, a groove 19 is inserted radially from outside into the perforated drum casing over the entire length of the working width and a clamping element 20 is inserted into the groove 19 so that it fits in the height and width of the groove 19. In addition, an indentation 21 is incorporated into the bottom of the groove 19, that is into the material thickness of the jacket 5 of the perforated drum, as shown in FIGS. 4, 5 and the clamping element 20 is bent into said groove, becoming enlarged radially. For this purpose the clamping element 20 can be made of spring steel and can have a bend 20′ over its length at the height of the indentation 21, corresponding to said indentation 21. If the outer covering 9 is now pulled over the perforated drum jacket 5 during assembly in the direction of the arrow 22 as shown in FIG. 4, this does not disturb the clamping element 20 fitted into the groove 19. When assembly of the outer covering 9 is finished, the clamping element 20 is displaced in the direction of the arrow 23 as shown in FIG. 5 relative to the indentation out of said indentation and into the situation as shown in FIG. 5. The bend 20′ of the clamping element 20 clamps the outer covering 9 with the perforated drum casing 5 in the clearance and brings the outer covering 9 in frictional contact around the perforated drum 5.

The clamping device according to FIGS. 4-6 can be executed many times over the working width of the perforated drum along a clamping element 20 and/or many times over the circumference. The radial enlargement 20′ of the clamping element 20 can be implemented by a bend as shown or in a different fashion e.g. by a thickening of the material, such as a welded seam or the like. The clamping element can be provided with a suitable perforation 25 over its length at the height of the perforation of the perforated drum casing 5, as shown in FIG. 6 to ensure uniform flow in this area of the drum.

In FIGS. 4-6, in order to increase the distance between the outer covering 9 and the perforated drum casing 5, a spunlace web 24 is also pulled on outside the perforated drum casing 5, which is doubled over but can also be omitted depending on the application.

1. A device comprising a rotatably mounted drum through which fluid flows from outside to inside, whose stable casing is provided over the circumference with a sieve-like perforated structure or the like, and is further provided with a likewise permeable outer covering which covers the casing radially on the outside and preferably an intermediate layer such as screen fabric is arranged between said covering and the casing of the perforated drum to increase the distance between the casing of the perforated drum and the outer covering, characterised in that a clamping element (20) extending in the axial direction and enlarged at least once in the radial direction over the working width of the perforated drum is mounted axially displaceably (23) between the outer surface of the casing of the perforated drum (5) and the inner surface of the outer covering (9).

2. The device according to claim 1, characterised in that the outer covering is formed of a perforated metal sheet (9) or a film.

3. The device according to claim 1, characterised in that the clamping element (20) is uniformly thick over its length but is directed at least once in the radial direction to a radial enlargement such as an arc (20′) or the like.

4. The device according to claim 1, characterised in that the clamping element (20) is constructed as narrow compared with its length (working width).

5. The device according to claim 1, characterised in that the clamping element (20) is arranged radially outside the perforated drum casing (5) and is held on said perforated drum casing.

6. The device according to claim 1, characterised in that the clamping element (20) is held in a fixed position in the circumferential direction of the perforated drum casing.

7. The device according to claim 6, characterised in that a radially inwardly directed groove (19) is inserted in the outer surface and over the working width of the perforated drum casing (5).

8. The device according to claim 7, characterised in that the clamping element (20) is inserted into the groove (19) and in the circumferential direction of the perforated drum such that in the event of axially directed pulling (22) of the outer covering (9) no additional resistance is formed and nevertheless the clamping element (20) is axially displaceable in the groove (19).

9. The device according to claim 6, characterised in that the clamping element (20) is in radial alignment with the circumferential surface of the perforated drum casing (5) in the mounted state before the clamping of the outer covering (FIG. 4, 6).

10. The device according to claim 1, characterised in that in the bearing area of the clamping element (20) and over the width of the clamping element (20) the perforated drum casing (5) is provided with a further radial indentation (21) in which the radial enlargement (20′) of the clamping element (20) lies in the mounted state.

11. The device according to claim 1, characterised in that for radial clamping of the permeable outer covering (9) the clamping element (20) is axially displaced (23) such that the radial enlargement (20′) of the clamping element (20) is displaced from the radial indentation (21) in the perforated drum casing (5) in the sense of bracing the outer covering (9) with the perforated drum casing (5).

12. The device according to claim 1, characterised in that the clamping element (20) has the radial enlargement (20′) and the perforated drum casing (5) has the indentation (21) in the groove (19) many times over the working surface.

13. The device according to claim 1, characterised in that the clamping element (20) has the same thickness over its length and for the radial enlargement (20′) is bent so that it fits into the indentation (21) of the groove (19) of the perforated drum casing (5) (FIG. 4).

14. The device according to claim 1, characterised in that the clamping element is made of spring steel.

15. The device according to claim 1, characterised in that the clamping element (20) is provided over its width and length with perforation (25) suitable for the perforated drum casing (5) for flow through the clamping element (20).
